(19) United States
(12) Patent Application Publication
(10) Pub. No.: US 2014/0109526 A1
(43) Pub. Date: Apr. 24, 2014

(54) Carboy With Permanent Closure and Method of Filling a Carboy

(71) Applicant: ROUSH LIFE SCIENCES, LLC, Livonia, MI (US)

(72) Inventors: Thomas Taylor, Windham, NH (US); Michael Price, Pelham, NH (US); George Jordan, Worcester, MA (US)

(73) Assignee: ROUSH LIFE SCIENCES, LLC, Livonia, MI (US)

(21) Appl. No.: 13/658,441

(22) Filed: Oct. 23, 2012

(51) Int. Cl. B67C 3/02; B65B 3/04; B65D 51/16

(52) U.S. Cl. 53/467; 141/178; 215/307

(57) ABSTRACT

A carboy has a rigid body forming an interior chamber for receiving a liquid. The chamber has a wall terminating at an opening and maintains a substantially constant shape at room temperature. The carboy also has a closure permanently secured to the opening for forming a sealed connection with the rigid body, and a plurality of tubes extending from the plurality of ports in the closure to fluidly connect with a carboy circuit. The closure has a plurality of ports for selectively providing access to the interior chamber, where at least one of the tubes extends out of the interior chamber. The at least one tube also extends inwardly from the closure and into the interior chamber.

### FIELD OF THE INVENTION

The invention generally relates to filling carboys and containing material and, more particularly, the invention relates to carboys used for dispensing and containing material.

### BACKGROUND OF THE INVENTION

Carboys have been used for many years for containing and transporting a wide variety of materials. For example, among other things, carboys have been used for containing and transporting beverages, granular material, hazardous waste, and laboratory chemicals. In fact, the pharmaceutical industry commonly transports large quantities of medicine in conventional carboys. To those ends, conventional carboys typically have a body with an interior chamber for containing material (e.g., medicine), and a cover for retaining the material within the interior chamber.

In the medical industry, a single two-liter carboy can contain tens of thousands, or even hundreds of thousands of dollars of medicine. In that case, carboy reliability often is critical. Moreover, some medical industry regulations further require that carboys containing certain medicine be substantially tamperproof during transport.

### SUMMARY OF VARIOUS EMBODIMENTS

In accordance with one embodiment of the invention, a carboy has a rigid body forming an interior chamber for receiving a liquid. The chamber has a wall terminating at an opening and maintains a substantially constant shape at room temperature. The carboy also has a closure permanently secured to the opening for forming a sealed connection with the rigid body, and at least one tube extending from the plurality of ports in the closure to fluidly connect with a carboy circuit. The closure has a plurality of ports for selectively providing access to the interior chamber, where at least one of the tubes extends out of the interior chamber. The at least one tube is sealable to seal the interior chamber, and configured to be connectable with a carboy circuit before it is sealed.

The body may be formed from plastic, while the closure may have an elastomeric body and a sealing member permanently securing the elastomeric body to the rigid body. Among other connection types, the sealing member can form a snap fit connection with the body, or it may be integral with the body. For example, integral connection types may include a sealing member welded to the body. As another example, the integral connection type may include a carboy where the sealing member is molded as part of the body (e.g., a two-shot molded component).

The plurality of tubes may include a barb for connecting with a flexible hose. Alternatively, or in addition, the plurality of tubes may include a flexible hose. The plurality of tubes may be substantially integral with a portion of the closure. In either case, or in other cases, the plurality of tubes each may include a weld to seal the interior chamber.

The carboy may have medication within the interior chamber. To preserve sterility, the plurality of tubes may be permanently occluded to seal the interior chamber.

Some embodiments have a cap permanently secured to and sealing a given one of the tubes. The cap can have a tab for removing the permanent connection of the cap and the tube. Alternatively, or in addition, a seal may cover the open end of one of the plurality of tubes, where the one tube has a “tube non-permanent connector” about its outside surface. In a corresponding manner, carboy further includes a cap having a “cap non-permanent connector” capable of mating with the tube non-permanent connector. The cap and one tube thus form a non-permanent connection when the mated.

Various embodiments also have a carboy circuit with a filling circuit connected with one of the tubes. The carboy circuit also has a venting circuit connecting with one of the tubes. Moreover, the rigid body typically has a bottom portion and a top portion. The top portion forms the opening, and the bottom portion opposes the top portion and is substantially flat. The rigid body also may form an integral handle.

In accordance with another embodiment of the invention, a method of dispensing a material provides a plurality of carboys. At least one of the carboys has a rigid body forming an interior chamber having an opening. The rigid body maintains a substantially constant shape at room temperature. The at least one carboy also has a closure permanently secured to the opening. The closure has a plurality of tubes to provide access to the interior chamber, where at least one of the tubes extends inwardly from the closure and into the interior chamber. Next, for each carboy, the method connects its tube with a carboy circuit, and directs material through the carboy circuit and into each carboy via its tube. The method then permanently occludes the carboy tubes to seal their interior chambers.

In accordance with other embodiments, a material filling kit has a plurality of carboys, and a plurality of packages that each has a sterile interior. Each sterile interior contains one or more of the carboys. At least one of the carboys includes a rigid body forming an interior chamber for receiving a liquid and having a wall terminating at an opening. The rigid body maintains a substantially constant shape at room temperature. The carboy(s) further have a closure permanently secured to the opening to form a sealed connection with the rigid body. The closure has a plurality of ports for selectively providing access to the interior chamber. Moreover, the carboy(s) also have a plurality of tubes extending from the plurality of ports in the closure to fluidly connect with a carboy circuit. At least one of the tubes both extends out of the interior chamber and extends inwardly from the closure and into the interior chamber.

In accordance with still other embodiments, a carboy includes a rigid body forming an interior chamber for receiving a liquid. The chamber has a wall terminating at an opening and maintains a substantially constant shape at room temperature. The rigid body is blow molded or injection molded. The carboy also has a closure permanently secured to the opening. The closure has a portion that connects with the opening to form a sealed connection with the rigid body. In addition, the closure also has a plurality of ports for selectively providing access to the interior chamber. This plurality of ports exposes the interior chamber to the exterior of the chamber when not occluded. The carboy also has a plurality of tubes extending from the plurality of ports in the closure to fluidly connect with a carboy circuit. This plurality of tubes extends out of the interior chamber, and at least one tube extends inwardly from the closure and into the interior chamber.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a carboy circuit that may be used in accordance with illustrative embodiments of the invention.

FIGS. 2A-2C schematically show three views of a carboy having a first snap-fit connection configured in accordance with illustrative embodiments of the invention.

FIG. 3 schematically shows an exploded view of the carboy shown in FIGS. 2A-2C.

FIG. 4A schematically shows a cross-sectional view of the carboy shown in FIGS. 2A-2C.

FIG. 4B schematically shows an enlarged view of the circled portion of the carboy shown in FIG. 4A.

FIGS. 5A-5F show various views a sealing member used the carboy FIGS. 2A-2C.

FIG. 6A schematically shows a side sealing carboy in accordance with another embodiment of the invention.

FIG. 6B schematically shows a cross-sectional view of the carboy shown in FIG. 6A.

FIGS. 7A-7D schematically show a carboy in accordance with another embodiment of the invention.

FIGS. 8A-8C schematically show a carboy in accordance with other embodiments of the invention.

FIGS. 9A-9C schematically show a carboy in accordance with still other embodiments of the invention.

FIGS. 10A and 10B schematically show a carboy in accordance with still another embodiment of the invention.

### DESCRIPTION OF ILLUSTRATIVE EMBODIMENTS

In illustrative embodiments, a carboy is both robust and easily transportable, while at the same time maintaining a sealed interior after filled with material, such as liquid medication. To that end, the carboy has a rigid body with the closure permanently secured to the opening of the body. Tubes extending from the closure selectively permit access to the interior of the container, and may be occluded to seal its interior. For example, the tubes may include rubber hoses that are heat sealed after the container is filled with medication. At that point, the interior of the container is sealed and tamperproof and thus, ready for storage or transportation to a remote location. Details of illustrative embodiments are discussed below.

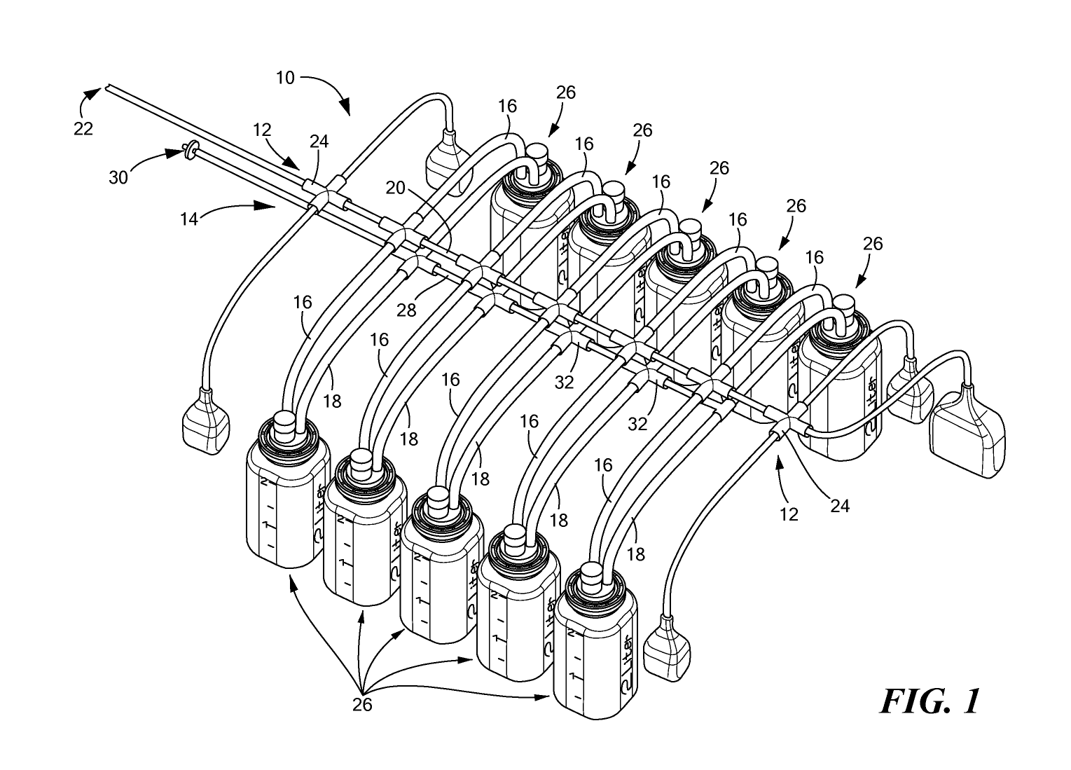

FIG. 1 schematically shows a carboy circuit 10 configured to use with illustrative embodiments of the invention. Specifically, the carboy circuit 10 may be used to fill a plurality of carboys 26 with some material. For exemplary purposes, the material contained in the carboys 26 is discussed as being pharmaceutical material (e.g., medication) or biotechnological material. It should be noted, however, that discussion of medication is to simplify the discussion and thus, is not intended to limit all embodiments invention. For example, the filling circuit 12 and carboys 26 may include other materials, in powder or liquid form, such as beverages, hazardous waste, and laboratory chemicals.

The carboy circuit 10 includes two sub-circuits; namely, a filling circuit 12 for directing material from a source and into the carboys 26, and a venting circuit 14 for permitting air within the carboys 26 to escape from the interior of the carboys 26 during the filling process. As discussed in greater detail below, each carboy 26 has separate filling and venting tubes 16 and 18 that respectively connect to the filling and venting circuits 12 and 14 of the carboy circuit 10.

To those ends, the filling circuit 12 has a filling backbone 20 with an inlet 22 for receiving medication from a source (e.g., a large, stationary container of medication), and a plurality of fill fittings 24 for connecting with filling tubes 16 extending from each carboy 26. In the embodiment shown, each fill fitting 24 includes a hollow cross-member directly connecting with two carboys 26. Among other ways, the filling tubes 16 from the carboys 26 may be overmolded into the filling backbone 20. In alternative embodiments, however, the filling tubes 16 may be removable from the filling backbone 20.

In a corresponding manner, the venting circuit 14 has a venting backbone 28 with an outlet 30 (e.g., having a filter) for venting air to the atmosphere, and a plurality of corresponding vent fittings 32 connecting with venting tubes 18 extending from each carboy 26. Structurally, the venting circuit 14 may looks similar to the filling circuit 12. For example, as in the embodiment shown, each vent fitting 32 includes a hollow cross-member directly connecting with two carboys 26. Among other ways, the venting tubes 18 from the carboys 26 may be overmolded into the venting backbone 28. In alternative embodiments, however, the venting tubes 18 may be removably connected with the vent backbone.

The entire carboy system may be distributed completely intact as shown in FIG. 1. This implementation thus lends itself well to the overmolded tubes. Alternatively, the carboy circuit 10 may be a permanent portion of a filling room, and the carboys 26 may be separate and attachable to the carboy circuit 10. In either case, the overall carboy system may be considered to be a kit including some or all of the features and components discussed above and shown in FIG. 1.

Before use, the system preferably is sterile and all or part of it may be contained within a sterile wrap. For example, a single wrap can cover the entire system. Alternatively, each of the carboys 26 and their tubes can be sealed within individual packages or bags (e.g., carboys 26 in one bag, and tubes in another bag). Accordingly, before use, the carboys 26 are removed in a sterile environment from their bags and connected to the carboy circuit 10. Next, the system directs medication from the filling circuit 12, through the filling backbone 20, and into each of the carboys 26. Of course, the medication displaces air within each of the carboys 26. Taking the path of least resistance, this displaced air thus is urged through the respective venting tubes 18, to the venting backbone 28 and into the environment through the vent outlet 30.

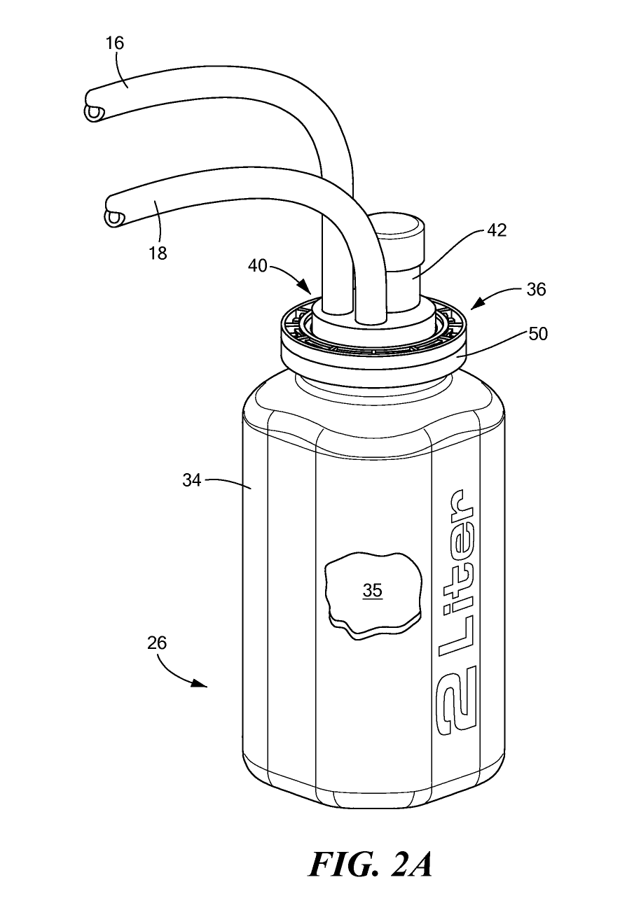

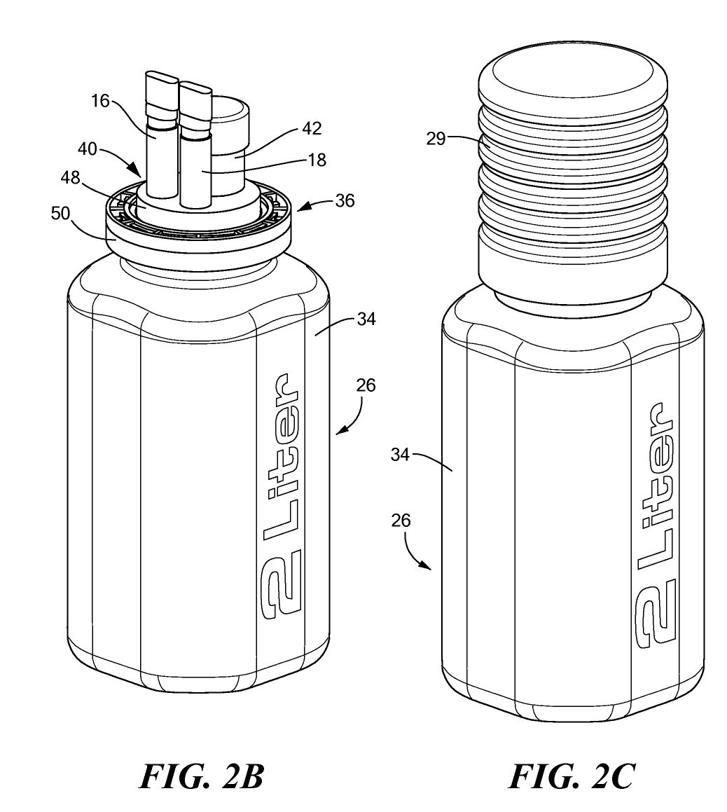

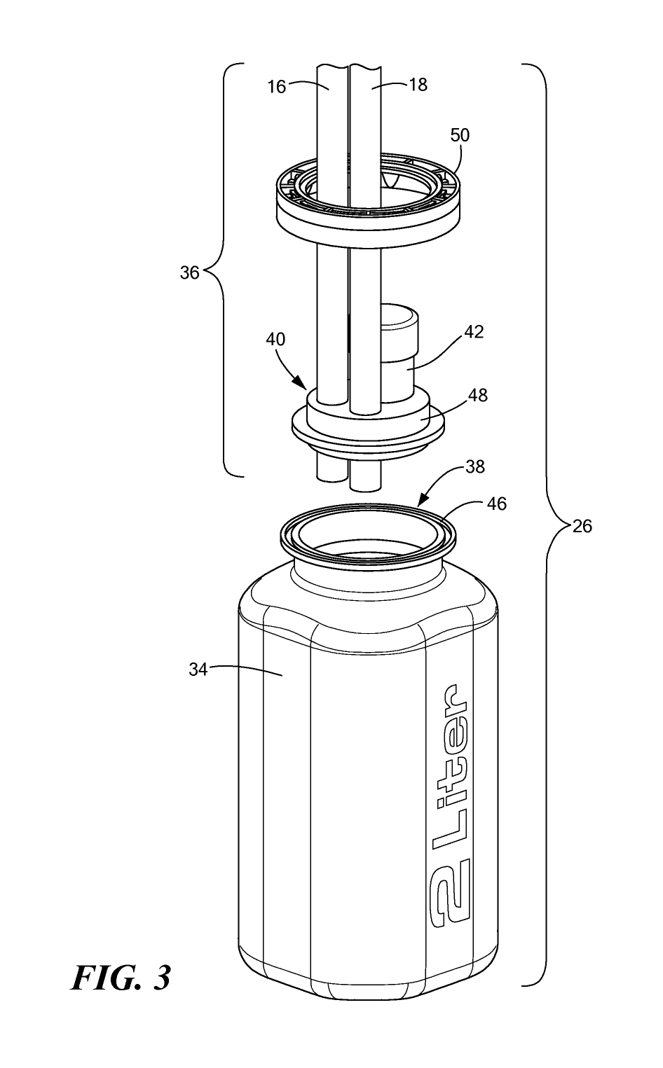

FIGS. 2A-2C schematically show a carboy 26 configured in one embodiment of the invention. FIG. 2A shows a perspective view of the carboy 26 detached from the carboy circuit 10. To that end, the carboy 26, which may include a bottle, includes a rigid body 34 forming an interior chamber 35 (shown in FIG. 2A in a cut-away portion of the rigid body 34) for receiving medication, and a closure 36 permanently secured to an opening 38 (FIG. 3, discussed below) at the top of the rigid body 34. To facilitate shipping and storage, the bottom of the rigid body 34 has a flat surface opposite to the opening 38.

The interior chamber 35/body 34 may be any of a number of different sizes or shapes. For example, the interior chamber 35 of the carboy 26 in FIG. 2A has a two liter capacity. Of course, any number of different sized interior chambers can suffice for different applications (e.g., 0.5-100 liters). In fact, a single carboy circuit 10 can include carboys 26 having different capacities. To facilitate manual or automated handling of the carboy 26, some embodiments also have an integral handle (not shown) molded into the rigid body 34.

In illustrative embodiments, the rigid body 34 maintains its shape at room temperature. Accordingly, the rigid body 34 may be any of a number of materials that have this property. For example, the rigid body 34 may be a hard, relatively inflexible plastic formed using injection molding or blow molding processes. Other embodiments may use metals, glass, or other material having the desired properties.

One or more ports 40, formed through the closure 36, permit access into the interior chamber 35. Each port 40 has a tube extending upwardly and, in some cases, inwardly with respect to the closure 36. For example, one tube may be a filling tube 16, while another tube may be a venting tube 18. As noted above, the filling tube 16 connects with the filling circuit 12, while the venting tube 18 connects with the venting circuit 14. In addition to the filling and venting tubes 16 and 18, the closure 36 also may have a drain tube 42 to facilitate chamber cleaning and removal of medication from within the carboy 26. Other embodiments may omit the drain tube 42. Instead, those embodiments may use one of the other tubes to also remove fluid from the interior chamber 35. For example, one of the other tubes 16 or 18 may extend deeply into the interior chamber 35, thus providing a satisfactory means for removing fluid using a vacuum. Yet other embodiments may have one tube only extending through the closure 36.

In the embodiment shown, two of the tubes 16 and 18 are rubber hoses extending integrally from the closure 36. The third tube, the drain tube 42, is a rigid plastic tube, also extending integrally from the closure 36 and having a closed end. Similar embodiments (e.g., other embodiments discussed below), however, may use flexible hoses for all three parts, rigid hoses for all three parts, or other combinations of rigid and flexible hoses/tubes. Moreover, the diameters of the different tubes 16, 18, and 42 can be the same, or they can vary. Other embodiments may use multiple tubes for a single port 40.

Rather than being positioned at the top of the rigid body 34, the closure 36 and ports 40 may be at a different location. For example, the rigid body 34 may have an irregular shape or other shape having the opening 38 on a surface that is at least partly facing radially (e.g., a side surface or an angled surface not directly facing upwardly from the perspective of the drawings). Accordingly, discussion of a top opening 38 is one of a variety of different implementations. In fact, some embodiments may place some ports 40 directly on the rigid body 34. For example, some embodiments may position a drain port/tube 42 on the side or bottom of the rigid body 34, and position the venting and filling ports/tubes 18 and 16 on the closure 36.

FIG. 2B schematically shows the carboy 26 after it has been filled and sealed. Specifically, after the carboy circuit 10 fills the carboy 26, an operator or some other means crimps, heat seals, and cuts the rubber hoses/tubes 16 and 18 at some point above the top surface of the closure 36. For example, the rubber hoses may be crimped, heat sealed, and cut approximately 2 to 3 inches above the top surface of the closure 36. After it is sealed, an optional protective covering 29 may be secured over the top section of the carboy 26 to protect the tubes during storage or transit (FIG. 2C).

The pharmaceutical industry often freezes medication within the carboys 26. Some of this medication may have completed their reaction to form the medication, or may be continuing to react. In either case, it is important to protect the closure 36 and apparatus extending from the closure 36. To that end, the protective covering 29 may include a bellows or some other protective structure. The carboy 26 may be opened by penetrating the drain tube 42, or by drawing the fluid out through one of the venting or filling tubes 18 or 16. In the latter case, the tubes 18 and 16 may be cut below the heat seals.

FIG. 3 schematically shows an exploded view of the carboy 26 of FIGS. 2A-2C. As shown, the interior chamber 35 of the rigid body 34 terminates at a top opening 38 that receives and permanently connects with the closure 36. The opening 38 has a lip 46 forming a flange for receiving the closure 36. In this case, the closure 36 has two primary components: an elastomeric body 48 for sealingly connecting with the perimeter of the opening 38 (e.g., formed as a shallow cylinder), and a coupling member 50 (also referred to as a “sealing member 50”) normally applying a force to provide the noted sealing connection. In illustrative embodiments, the coupling member 50 is substantially rigid (e.g., a hard plastic) and acts as a sealing ring to provide a permanent snap-fit connection with the bottom of the lip 46. This permanent connection normally provides a longitudinally directed (downward) force against the elastomeric body 48 to seal the opening 38.

It should be noted that a “permanent” connection requires a connection that cannot be easily removed without using undue force damaging the carboy 26. More specifically, a connection is considered to be permanent when removal or separation of the two parts would break or very likely could cause damage through the necessary use of undue force. In the example using a snap-fit connection, removal of the sealing ring with undue force may damage the opening lip 46 or coupling member 50. This is in contrast to a very tightly coupled cap using threads, which is intended to be removed without damaging the parts—i.e., a removable, non-permanent connection. This also is in contrast to a snap-fit having flexible materials that can be removed without undue force and thus, without significant risk of damaging the components.

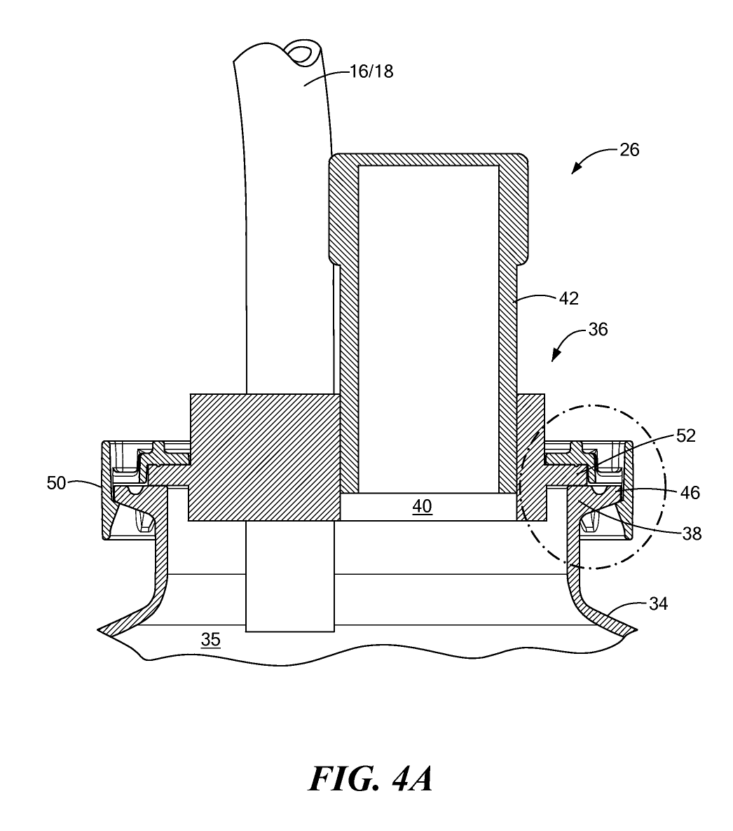

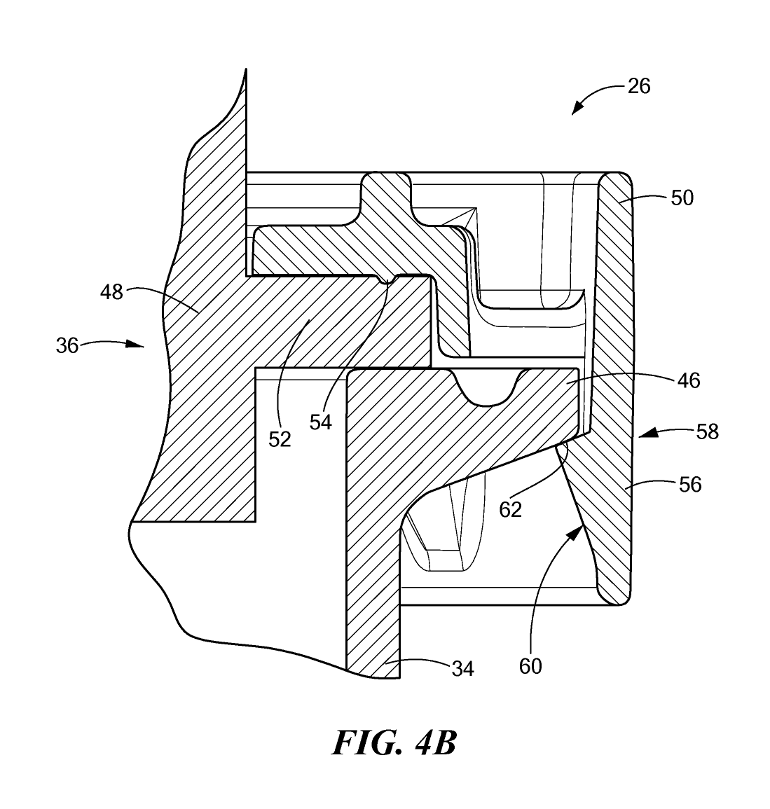

FIG. 4A schematically shows a cross-sectional view of the interface between the closure 36 in the opening 38 of the rigid body 34. FIG. 4B schematically shows an enlarged view of the circled portion of the carboy 26 shown in FIG. 4A. As shown, a radially flanged portion 52 of the elastomeric body 48 rests on a top surface of the opening 38. In a corresponding manner, the coupling member 50 has an annular ridge 54 extending downwardly and into the elastomeric material of the top facing surface of the elastomeric body 48. This interference fit should sufficiently seal the opening 38 of the rigid body 34. To provide sufficient force and permanent connection, however, the sealing member 50 also has an annular skirt 56 with a plurality of locking portions 58 extending around its inner periphery. Each locking portion 58 has an angled slide surface 60 and locking ledge 62. To provide a secure connection, the locking ledge 62 preferably has an angle that is about the same angle as that of the bottom of the opening lip 46.

Accordingly, during assembly, the opening flange/lip 46 may slide up the angled slide surface 60, urging the annular skirt 56 outwardly. Just after the top of the angled slide surface 60, the annular skirt 56 snaps inwardly, where its angled locking ledge 62 locks face to face with the similarly angled underside of the flange/lip 46. In other words, the locking portions 58 effectively provide a part of a clamp about the opening lip 46. This simultaneous connection with a plurality of locking portions 58 should provide sufficient force for sealing and make removal significantly difficult absent undue force and potential component breakage. This permanent connection ensures that the material in the interior chamber 35 is substantially tamper-free until the user receives the sealed carboy 26.

FIG. 4A also shows the substantially unitary nature of the drain tube 42. In this embodiment, the drain tube 42 is thermally bonded to a port 40 of the closure 36 and has a closed end. In other embodiments, however, the drain tube 42 may be formed from the same material as the closure 36 and be an integral part of it. Accordingly, to access the interior chamber 35 for drainage, an end-user must forcibly remove a portion of the drain tube 42. This figure and others also show how the tubes (identified as “tube 16/18 since the tube shown can be either the filling or venting tube) also extend into the interior chamber 35 of the rigid body 34. Although the tubes are not shown as extending very deeply within the interior chamber 35, some embodiments may extend all the way to the bottom (of the interior chamber 35) to permit easy removal using suction or other medication removal mechanism.

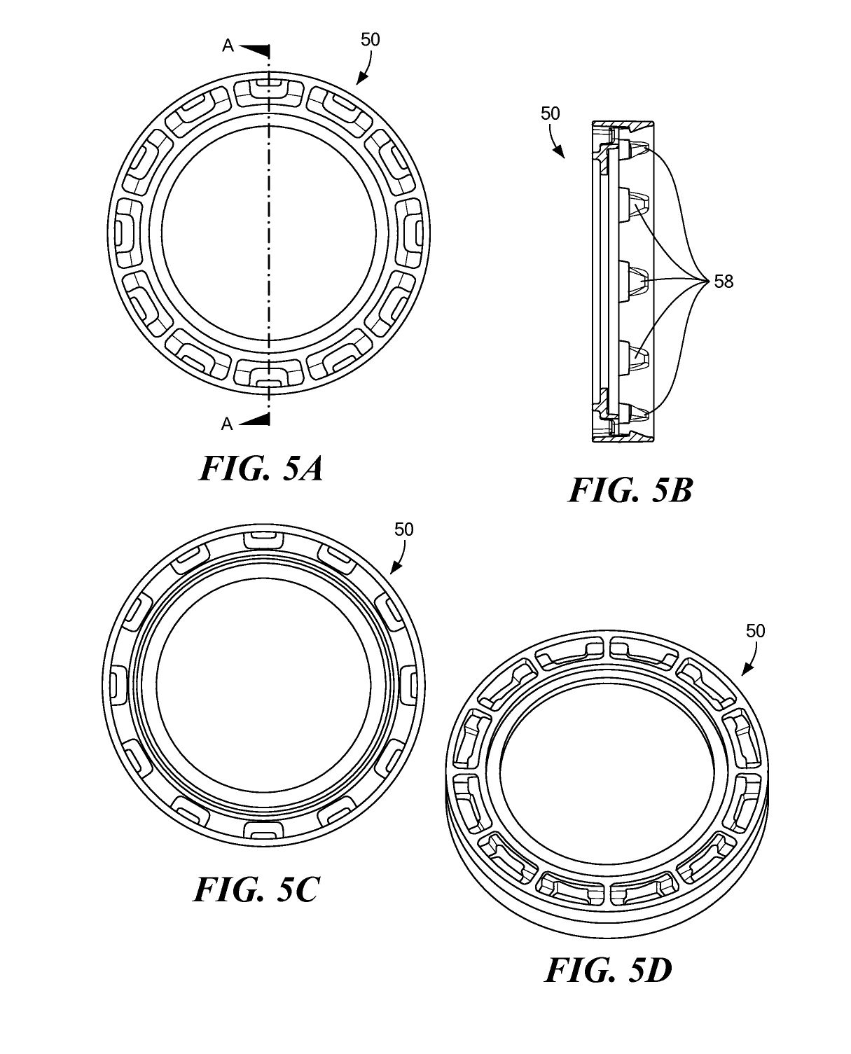

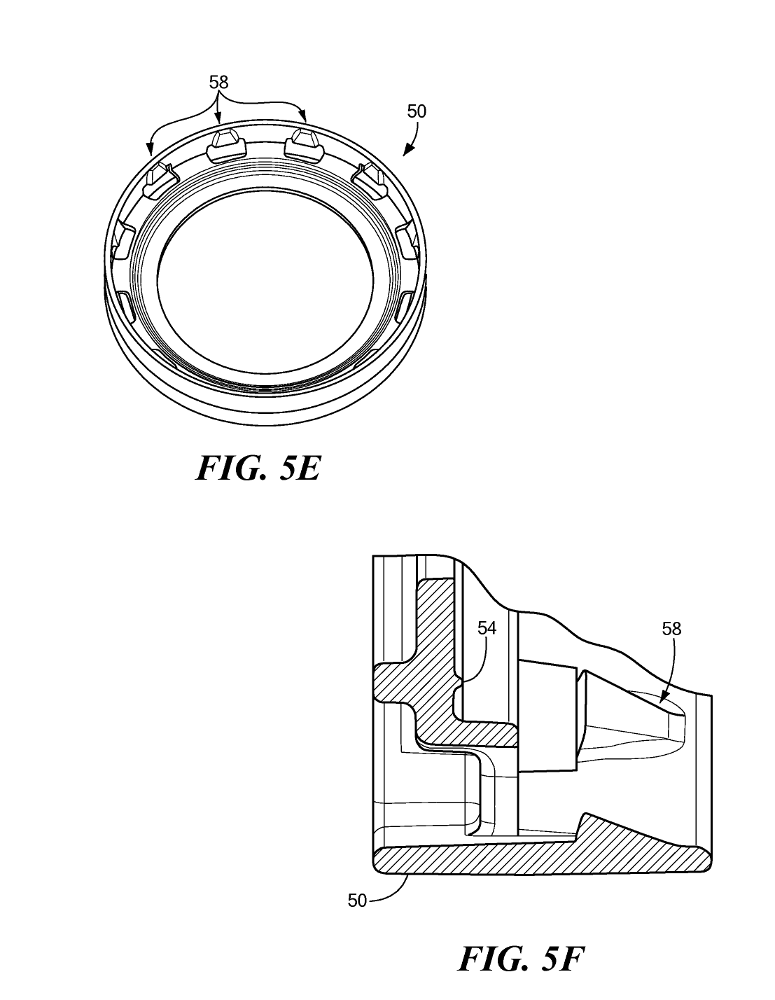

The sealing member 50 may have any of a variety of structures for accomplishing its function. To that end, FIGS. 5A-5F schematically show different views of one embodiment of the sealing member 50. Specifically, FIGS. 5A and 5D show a top view of the sealing member 50, while FIG. 5B shows section A-A across FIG. 5A. FIGS. 5C and 5E show a bottom side view of the sealing member 50, while FIG. 5F shows an enlarged view of the circled portion of FIG. 5B. As shown, this embodiment has twelve locking portions 58 evenly spaced above the outer periphery of the annular skirt 56. This view also more clearly shows the annular ridge 54 that normally presses into the elastomeric body 48.

Those skilled in the art should understand that a snap-fit connection is one of many potential permanent connections. For example, the coupling member 50 may be welded or glued to the opening 38. In yet other embodiments, the coupling member 50 may be overmolded with the elastomeric member (e.g., using a two-shot injection molding process), or molded with the rigid body 34. Accordingly, discussion of a snap-fit connection is for illustrative purposes only and should not limit all embodiments the invention.

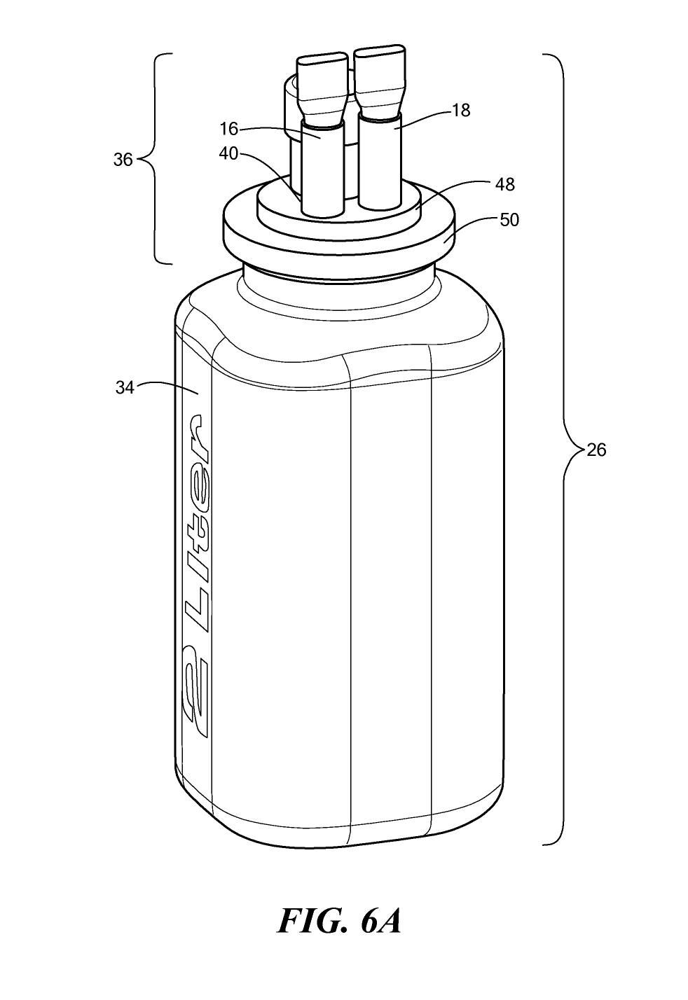

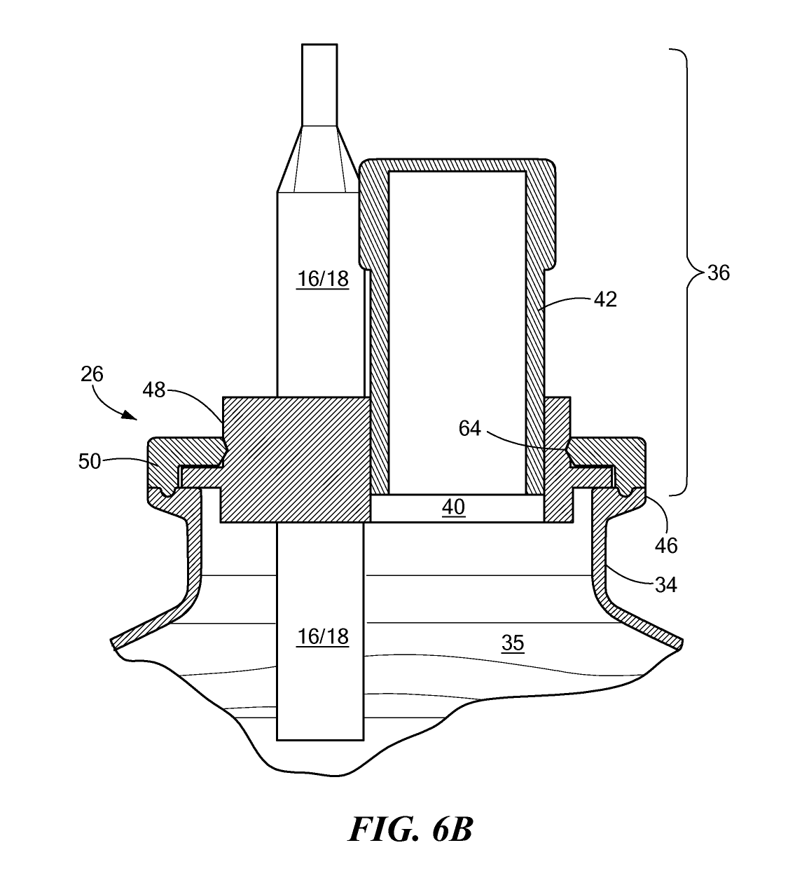

Rather than using the annular ridge 54 to provide a downwardly directed seal, some embodiments may use a radially directed annular ridge 64 extending radially inwardly to provide the same seal. FIGS. 6A and 6B schematically show one such embodiment. More specifically, FIG. 6B schematically shows a cross-sectional view of the top portion of the carboy 26 shown in FIG. 6A. This view clearly shows the inwardly projecting annular ridge 64 abutting and protruding into the elastomeric body 48. Moreover, unlike the embodiment of FIGS. 2A-2C, this embodiment ultrasonically welds the coupling member 50 to the top surface of the opening 38. Accordingly, the coupling member 50 provides a radial seal with the main portion of the elastomeric body 48. In fact, for further sealing, some embodiments may use an additional downwardly facing annular ridge 54 similar to that described above.

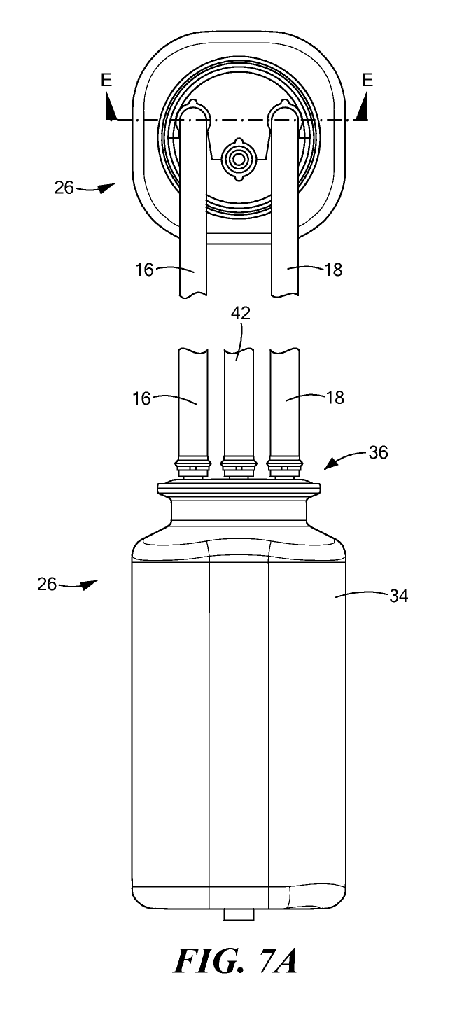

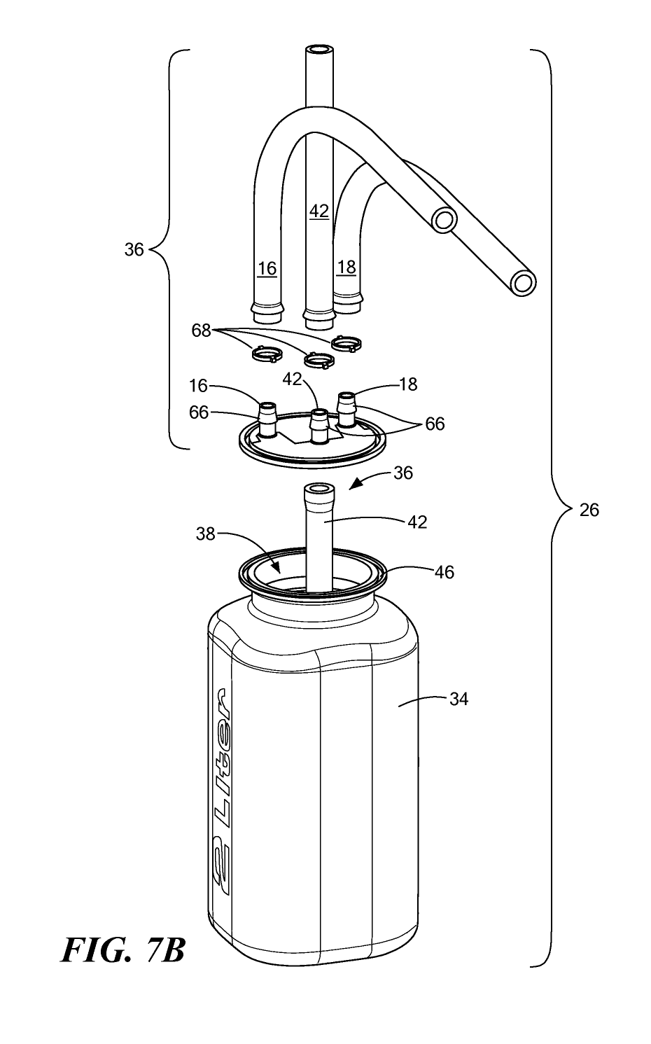

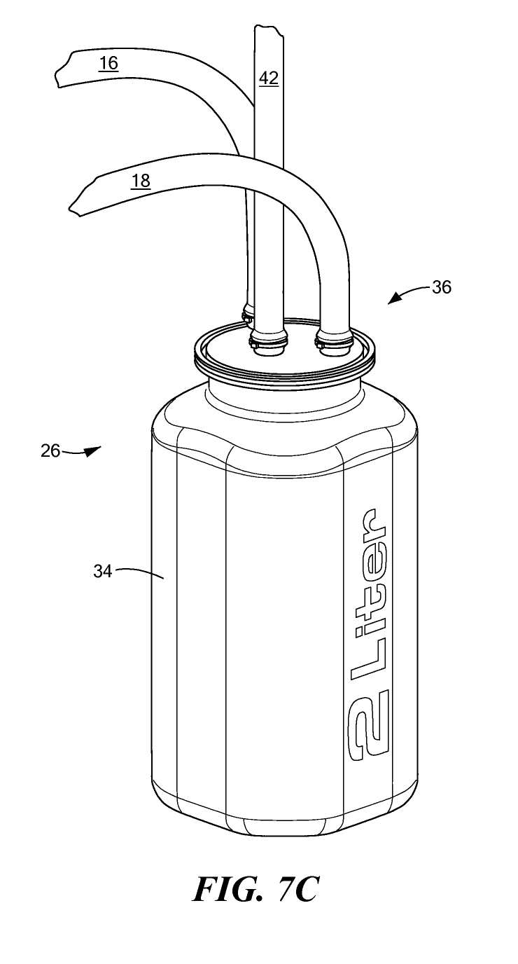

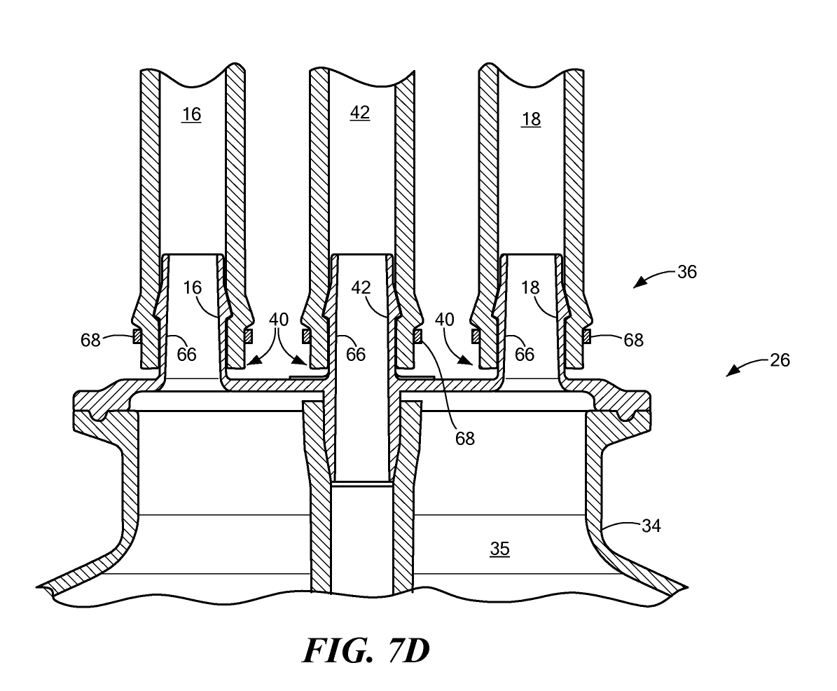

Some implementations do not require built in flexible hoses like those embodiments discussed above. To that end, FIGS. 7A-7D schematically show another embodiment having vertically oriented hose barbs 66 extending from the top of the closure 36. The hose barbs 66 may be sized to form a standard connection with a flexible hose having an interior diameter corresponding with its outside diameter. To that end, FIG. 7A schematically shows a top and side view of this embodiment having attached hoses, 7B schematically shows an exploded view of the same carboy 26, while FIG. 7C shows a perspective view of the same carboy 26. In addition, FIG. 7D schematically shows a cross-sectional view across line E-E of the top view shown in FIG. 7A.

In a manner similar to the embodiment of FIG. 6A, the closure 36 of this embodiment also may be integral with the mouth of the rigid body 34. To that end, the closure 36 may be welded or glued to the rigid body 34. In alternative embodiments, the closure 36 may be molded as a single part with the rigid body 34 (i.e., unlike some other embodiments, it exhibits no visible boundary with the rigid body 34). In either case, the closure 36 of this embodiment may be a single piece, such as a single plastic piece. Accordingly, this embodiment (and other embodiments) may omit the elastomeric body 48.

To more securely connect the rubber hoses to the barbs 66, the carboy 26 also may secure a plurality of tamperproof clamping wraps 68 about the bases of each rubber hose. One of the barbs 66 may connect with an internal tube extending downwardly toward the bottom of the interior chamber 35. This interior tube should provide the requisite drainage by vacuum or other means. Alternative embodiments may use a two-piece closure for the carboy 26 of FIGS. 7A-7C.

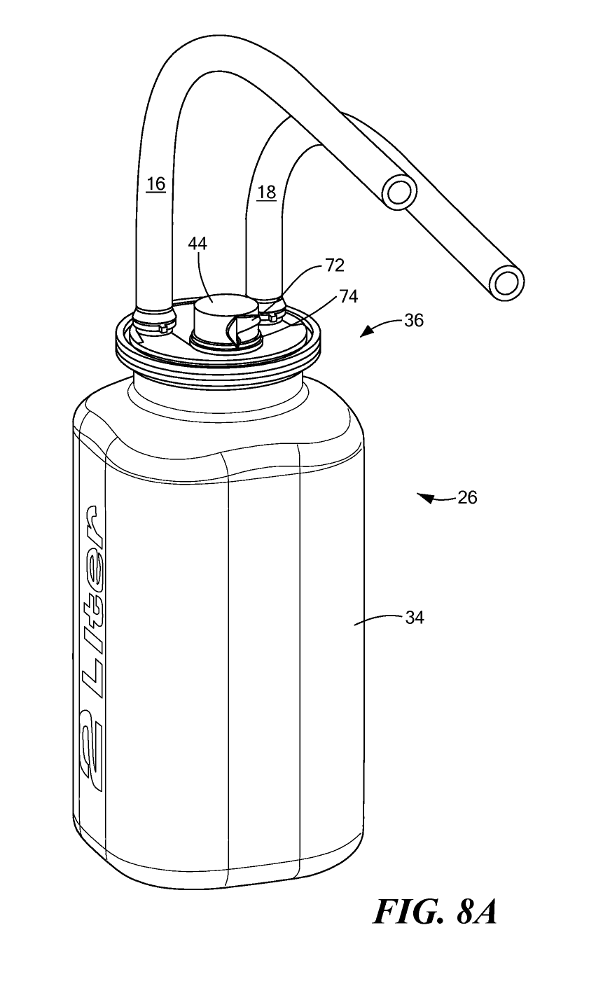

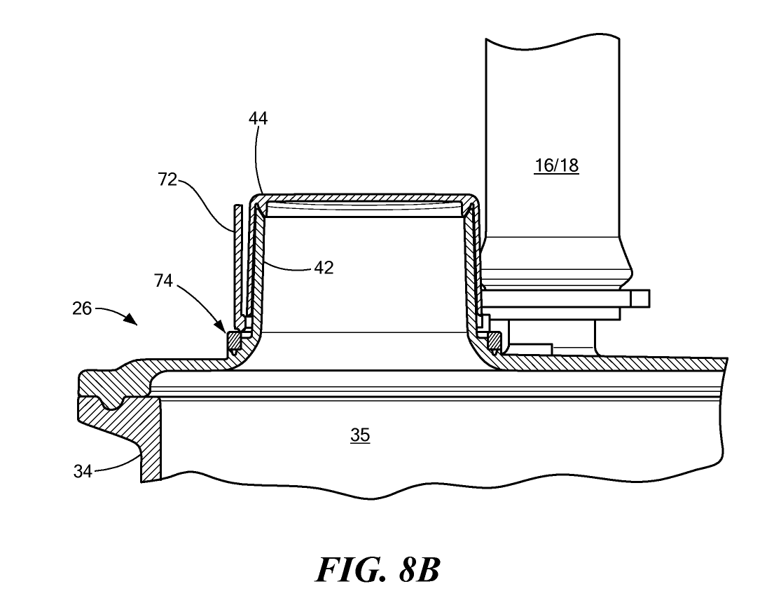

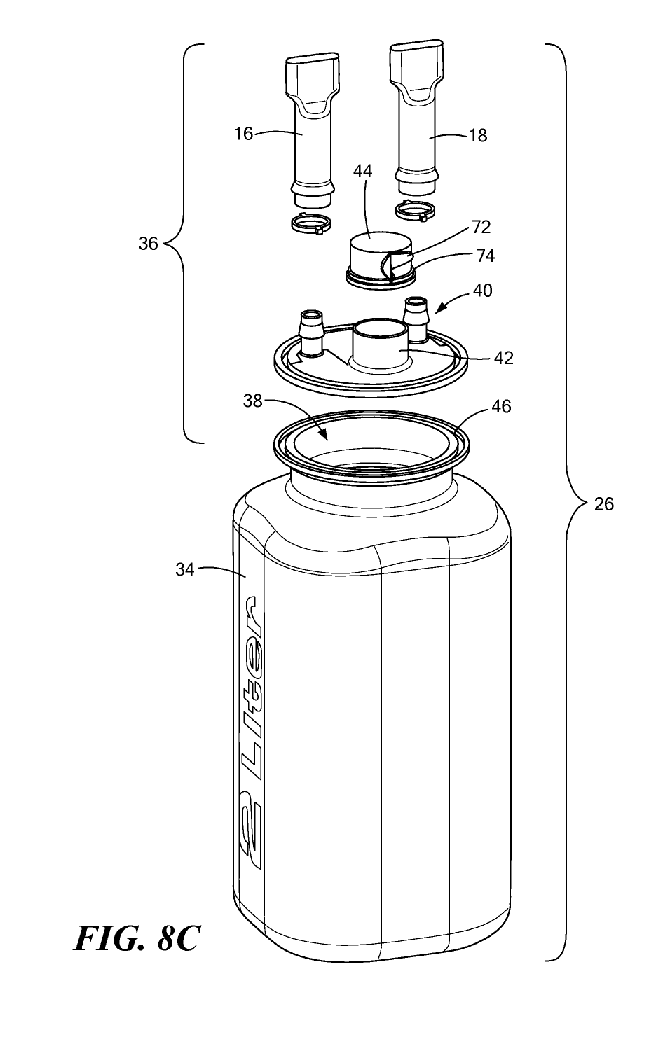

FIGS. 8A-8C show another embodiment of the carboy 26 and is similar to other embodiments. Specifically, in a manner similar to the embodiment shown in FIGS. 7A-7D, this embodiment has a single piece closure 36 permanently and integrally connected with the opening 38 of the rigid body 34. Unlike that embodiment, however, this embodiment also has a relatively wide drain tube 42 similar to that shown in FIGS. 6A and 6B. As discussed above, the drain tube 42 of FIGS. 6A and 6B requires some external means, such as a knife, to open the drain tube 42. The embodiment in FIGS. 8A-8C, however, has a simple mechanism for opening the drain tube 42.

In particular, this embodiment has a cap 44 permanently secured to the drain tube 42. To enable easy and permanent removal, the cap 44 has a pull tab 72 that, when pulled in a certain manner, removes a weakened annular portion 74 of the cap 44. The pull tab 72 thus may be formed from a material that is weak in this region. A thin layer of plastic, for example, should provide satisfactory results. To avoid potential debris from falling into the medication when separating the tab 72, the weakened portion 74 preferably is near the base of the drain tube 42. After it is removed, the cap 44 may be reinserted onto the drain tube 42, although it no longer is permanently connected.

Of course, this embodiment using the pull tab 72 may have different features than those of the drawings. For example, rather than using barbs 66, this embodiment also can use integral flexible hoses extending from the radially interior portion of the closure 36. In addition, or alternatively, this embodiment also may use a two piece closure 36 design, and/or have additional ports 40. Indeed, other embodiments have similar component interchangeability. Accordingly, this is not the only embodiment they can have different features than those shown in the other embodiments.

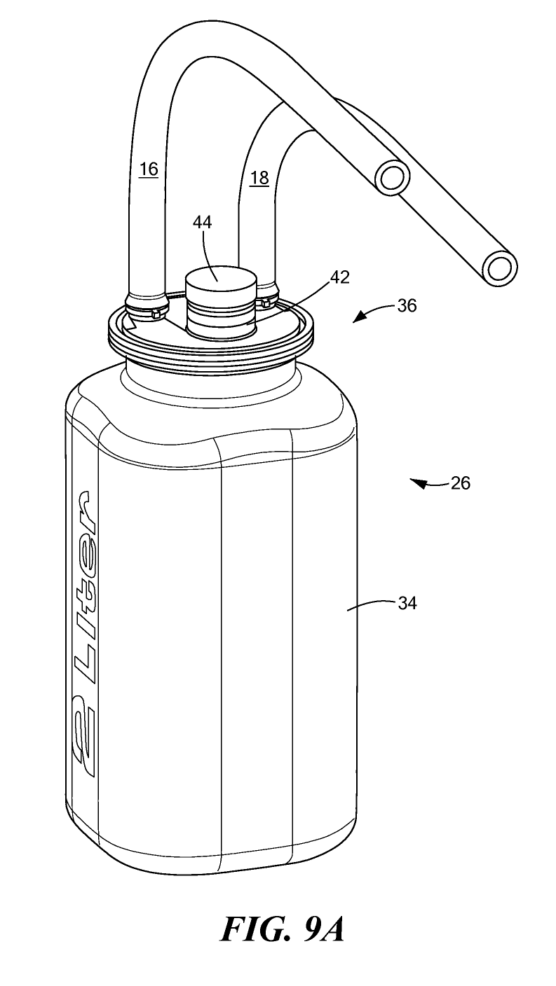

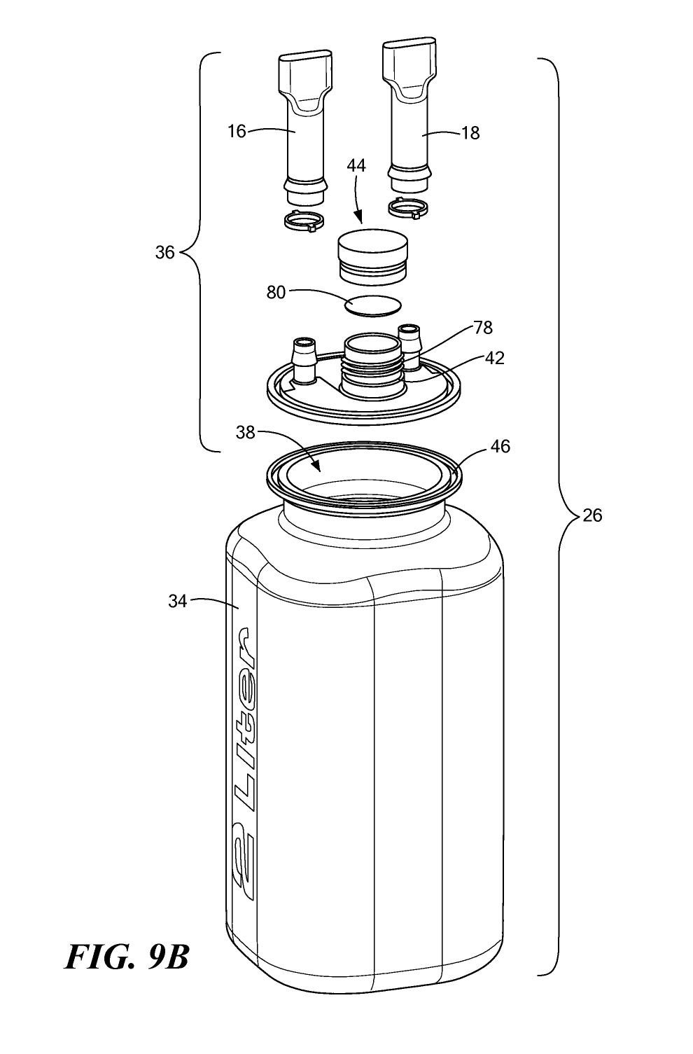

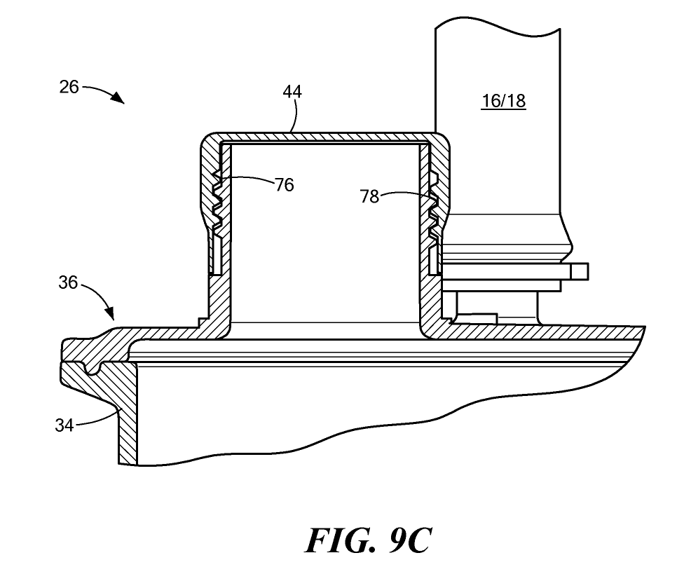

FIG. 9A through 9C show another embodiment similar to that discussed above with regard to FIGS. 8A-8C. Unlike that embodiment, however, this embodiment has a cap 44 that is removably connectable with the drain tube 42. Specifically, the cap 44 has interior threads 76 that mate with exterior threads 78 on the outside of the drain tube 42. Accordingly, a user may remove the drain cap 44 and reattach it using this conventional connection. To ensure sterility immediately after filling, however, the carboy 26 also has a seal member 80 permanently connected about the opening of the drain tube 42. For example, the seal member 80 may include an induction heat sealed liner secured over the drain tube 42. Of course, other embodiments may use other types of seal members 80. For example, a thin plastic seal, or elastomeric seal should provide satisfactory results.

To remove the material from within the rigid body 34/interior chamber 35, a user forcibly removes or damages the seal member 80. For example, the seal member 80 may be removable using a pull tab 72 similar to that discussed above with regard to FIGS. 8A-8C. Other embodiments may have a spike or other sterile devices to penetrate through the seal member 80. After piercing or penetrating the seal member 80 and removing the material, one may attach the removable cap 44 back to the drain tube 42.

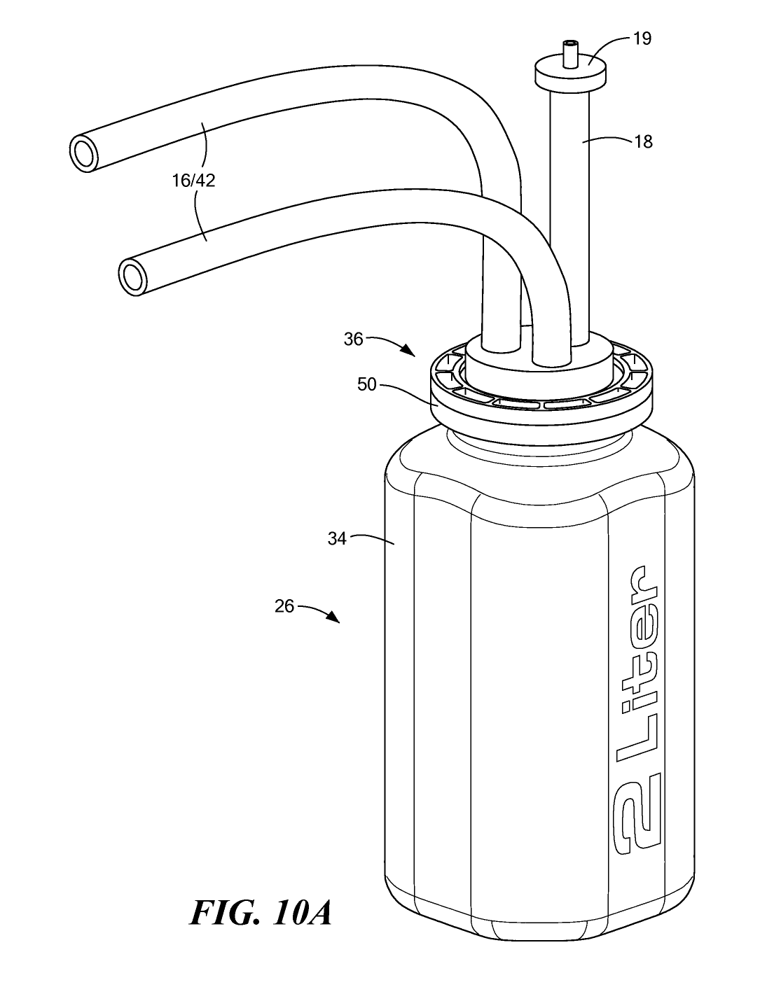

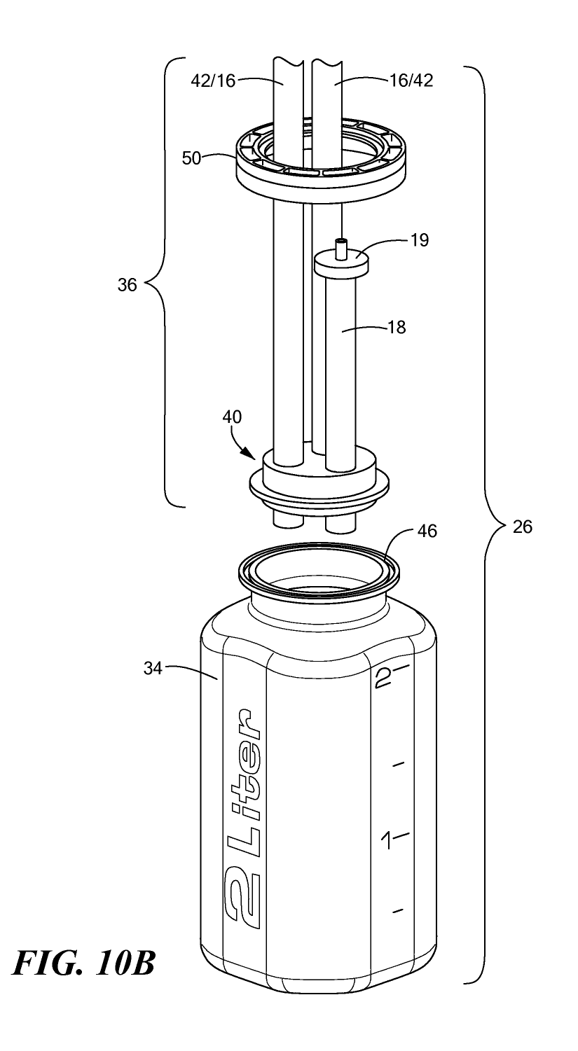

FIGS. 10A and 10B schematically show another embodiment of the invention in which the venting tube 18 (e.g., either a flexible hose or rigid bar and hose combination) has a filter 19 at its terminal end. This embodiment thus does not need to be connected with the vending circuit 14 and thus, vents into the local atmosphere. The filter 19 may be removable or permanently connected. If removable, then when removed, the venting tube 18 may be connected with the venting circuit 14 if desired. This embodiment also has two other tubes, which can include at least one filling tube 16 and, in some embodiments, a drain tube 42. This embodiment can have many of the features of other embodiments, such as, among other things, a permanent snap fit connection like those shown in FIGS. 2A-6B.

Accordingly, illustrative embodiments provide the advantages of a rigid carboy 26 while ensuring that its internal material is not tampered with prior to opening.

Although the above discussion discloses various exemplary embodiments of the invention, it should be apparent that those skilled in the art can make various modifications that will achieve some of the advantages of the invention without departing from the true scope of the invention.

What is claimed is:

1. A carboy comprising:
a rigid body forming an interior chamber for receiving a liquid, the chamber having a wall terminating at an opening, the rigid body maintaining a substantially constant shape at room temperature, the interior chamber being sterile;
a closure permanently secured to the opening, the closure forming a sealed connection with the rigid body, the closure having a plurality of ports for selectively providing access to the interior chamber; and
at least one tube extending from the plurality of ports in the closure to fluidly connect with a carboy circuit,
at least one of the tubes extending out of the interior chamber, the at least one tube being sealable to seal the interior chamber, the at least one tube being configured to be connectable with a carboy circuit before it is sealed.

2. The carboy as defined by claim 1 wherein the body comprises plastic and the closure comprises an elastomeric body.

3. The carboy as defined by claim 2 wherein the closure further comprises a sealing member permanently securing the elastomeric body to the rigid body.

4. The carboy as defined by claim 3 wherein the sealing member forms a snap fit connection with the body.

5. The carboy as defined by claim 3 wherein the sealing member is integral with the body.

6. The carboy as defined by claim 5 wherein the sealing member is welded to the body.

7. The carboy as defined by claim 5 wherein the sealing member and elastomeric body are two-shot molded together.

8. The carboy as defined by claim 1 wherein the closure is welded to the rigid body.

9. The carboy as defined by claim 1 wherein the plurality of tubes comprises a barb for connecting with a flexible hose.

10. The carboy as defined by claim 1 wherein the plurality of tubes comprises a flexible hose.

11. The carboy as defined by claim 1 further comprising medication within the interior chamber, the plurality of tubes being permanently occluded to seal the interior chamber.

12. The carboy as defined by claim 11 wherein the plurality of tubes each include a weld to seal the interior chamber.

13. The carboy as defined by claim 1 wherein the plurality of tubes are substantially integral with a portion of the closure.

14. The carboy as defined by claim 1 further comprising a cap permanently secured to a given one of the tubes, the cap sealing the given tube, the cap having a tab for removing the permanent connection of the cap and the tube.

15. The carboy as defined by claim 1 further comprising a seal covering one of the plurality of tubes, the one tube comprising a tube non-permanent connector about its outside surface, the carboy further including a cap having a cap non-permanent connector capable of mating with the tube non-permanent connector, the cap and one tube having a non-permanent connection when the mated.

16. The carboy as defined by claim 1 further comprising a carboy circuit having a filling circuit connected with one of the tubes, the carboy circuit also having a venting circuit connecting with one of the tubes.

17. The carboy as defined by claim 1 further comprising pharmaceutical material within the interior chamber.

18. The carboy as defined by claim 1 wherein the rigid body has a bottom portion and a top portion, the top portion forming the opening, the bottom portion opposing the top portion and being substantially flat.

19. A method of dispensing a material, the method comprising:
providing a plurality of carboys, at least one of the carboys having a rigid body forming an interior chamber having an opening, the rigid body maintaining a substantially constant shape at room temperature, the at least one carboy also having a closure permanently secured to the opening, the closure having a plurality of tubes to provide access to the interior chamber, at least one of the tubes extending inwardly from the closure and into the interior chamber;
for each carboy, connecting its tube with a carboy circuit;
directing material through the carboy circuit and into each carboy via its tube; and
permanently occluding the carboy tubes to seal their interior chambers.

20. The method as defined by claim 19 wherein each tube comprises a flexible hose, permanently occluding comprising cutting and sealing the flexible hose on each carboy.

21. The method as defined by claim 19 wherein the material comprises a liquid.

22. The method as defined by claim 21 wherein the liquid comprises a medication.

23. The method as defined by claim 19 further comprising freezing at least one carboy with the material in its interior chamber.

24. The method as defined by claim 19 wherein the carboy circuit comprises a filling circuit, directing material through the carboy circuit comprising connecting at least one tube of each carboy to the filling circuit.

25. The method as defined by claim 24 wherein the carboy circuit further comprises a venting circuit, directing material through the carboy circuit comprising connecting at least one tube of each carboy to the venting circuit.

26. The method as defined by claim 19 wherein for each carboy, the body comprises plastic and the closure comprises an elastomeric body and a sealing member permanently securing the elastomeric body to the rigid body.

27. The method as defined by claim 19 wherein providing a plurality of carboys comprises removing each carboy from a package having a substantially sterile interior.

28. A material dispensing and filling kit comprising:
a plurality of carboys;
a plurality of packages that each having a sterile interior, each sterile interior containing at least one of the carboys, at least one carboy comprising:
a rigid body forming an interior chamber for receiving a liquid, the chamber having a wall terminating at an opening, the rigid body maintaining a substantially constant shape at room temperature;
a closure permanently secured to the opening, the closure forming a sealed connection with the rigid body, the closure having a plurality of ports for selectively providing access to the interior chamber; and
a plurality of tubes extending from the plurality of ports in the closure to fluidly connect with a carboy circuit,
at least one of the tubes extending out of the interior chamber,
the at least one tube extending inwardly from the closure and into the interior chamber.

29. The kit as defined by claim 28 wherein for each carboy, the body comprises plastic and the closure comprises an elastomeric body.

30. The kit as defined by claim 29 wherein for each carboy, the closure further comprises a sealing member permanently securing the elastomeric body to the rigid body.

31. The kit as defined by claim 28 further comprising a carboy circuit having a plurality of ports configured to connect with the plurality of carboy tubes.

32. The kit as defined by claim 28 wherein for each carboy, the plurality of tubes comprises a flexible hose.

33. A carboy comprising:
a rigid body forming an interior chamber for receiving a liquid, the chamber having a wall terminating at an opening, the rigid body maintaining a substantially constant shape at room temperature, the rigid body being blow molded or injection molded;
a closure permanently secured to the opening, the closure having portion that connects with the opening to form a sealed connection with the rigid body, the closure having a plurality of ports for selectively providing access to the interior chamber when not occluded, the plurality of ports exposing the interior chamber to the exterior of the chamber; and
a plurality of tubes extending from the plurality of ports in the closure to fluidly connect with a carboy circuit,
the plurality of tubes extending out of the interior chamber,
at least one tube extending inwardly from the closure and into the interior chamber.

34. The carboy as defined by claim 33 wherein the rigid body is injection molded.

35. The carboy as defined by claim 33 wherein the closure comprises an elastomeric body and a sealing member securing the elastomeric body to the rigid body.

36. The carboy as defined by claim 33 wherein the closure forms a snap fit connection with the rigid body.

37. The carboy as defined by claim 33 wherein the closure is integral with the rigid body.
